(19) United States
(12) Patent Application Publication
(10) Pub. No.: US 2006/0196075 A1
(43) Pub. Date: Sep. 7, 2006

(54) Hair dryer

(76) Inventors: Daniel Santhouse, Wilton, CT (US); Anthony Kit Lun Leung, Hong Kong (CN); Eric Chung Hon Wong, Hong Kong (CN)

Correspondence Address: STEVEN A. GARNER, ESQ.;CONAIR CORPORATION, ONE CUMMINGS POINT ROAD, STAMFORD, CT, 06902, US

(21) Appl. No.: 10/533,113

(22) PCT Filed: Nov. 8, 2002
(86) PCT No.: PCT/US02/35894

§ 371 Date: Mar. 22, 2006

(51) Int. Cl. A45D 20/12; F26B 3/34; A47K 10/48

(52) U.S. Cl. 34/96; 34/279; 392/380

(57) ABSTRACT

There is provided a hair dryer for quiet operative use that efficiently dampens noise created when fan impeller blades cut through the air and that acoustically insulates a motor to dampen vibrational noise generated thereby. The hair dryer of the present invention has a housing with an air inlet and an air outlet, a heater, an acoustically isolated motor, a fan operatively connected to the motor, an inner sleeve surrounding the fan and forming an air gap between the housing and the inner sleeve, and an outer sleeve surrounding at least a portion of the housing. In one embodiment, the inner annular sleeve has a plurality of guides for directing airflow. In another embodiment, the fan has one or more hubs with a plurality of propeller blades that cooperate with the housing and/or the inner sleeve to convert blade tip vortices into useful airflow, as well as to provide a noise dampening effect. In still another embodiment, the fan is positioned part-in and part-out of the housing. Other embodiments are described.

### BACKGROUND OF THE INVENTION

1. Field of the Invention

The present invention relates to a hair dryer for quiet operation. More particularly, the present invention relates to a hair dryer having a number of noise dampening features.

2. Description of the Prior Art

The present prior art provides a variety of techniques for quieting operational noise generated by conventional hair dryers during use. For example, U.S. Pat. No. 6,367,162, discloses the use of a brushless motor for creating less mechanical noise and yet providing for a larger volume of airflow. Further, U.S. Pat. No. 6,011,903, discloses the use of an first axial flow impeller in a housing for generating an ambient airflow therein, an outer duct secured to the housing, a second axial flow impeller located in the outer duct for generating an ambient airflow therein, and a motor positioned in a handle to minimize the noise and vibration inherent therewith. Notwithstanding the foregoing, there remains a need for an economical, efficient hair dryer capable of effective, quiet operation.

### SUMMARY OF THE INVENTION

It is an object of the present invention to provide a hair dryer for quiet operation.

It is another object of the present invention to provide a hair dryer that efficiently dampens noise created when fan impeller blades cut through the air.

It is still another object of the present invention to provide a hair dryer that acoustically insulates a motor and/or a fan to dampen vibrational noise generated thereby.

It is a further object of the present invention to provide a hair dryer that selectively augments airflow generated thereby.

These and other objects and advantages of the present invention are achieved by a hair dryer having a housing, a heater, an acoustically isolated motor, a fan operatively connected to the motor, an inner sleeve surrounding the fan, and an outer sleeve surrounding at least a portion of the housing.

### BRIEF DESCRIPTION OF THE DRAWINGS

The present invention is more fully understood by reference to the following detailed description of an illustrative embodiment in combination with the drawings identified below.

FIG. 1 is a side sectional view of a hair dryer in accordance with an illustrative embodiment of the present invention;

FIG. 2 is a side sectional view of a hair dryer in accordance with another illustrative embodiment of the present invention;

FIG. 3 is a broken away side, sectional view of the hair dryer of FIG. 2;

FIG. 4 is an broken away end, sectional view of an alternative embodiment to that reflected in FIGS. 2 and 3;

FIG. 5 is a side view of a hair dryer in accordance with still another illustrative embodiment of the present invention;

FIG. 6 is a side sectional view of a hair dryer in accordance with yet another illustrative embodiment of the present invention; and

FIG. 7 is a side, sectional view of a hair dryer in accordance with yet still another illustrative embodiment of the present invention.

### DETAILED DESCRIPTION OF THE INVENTION

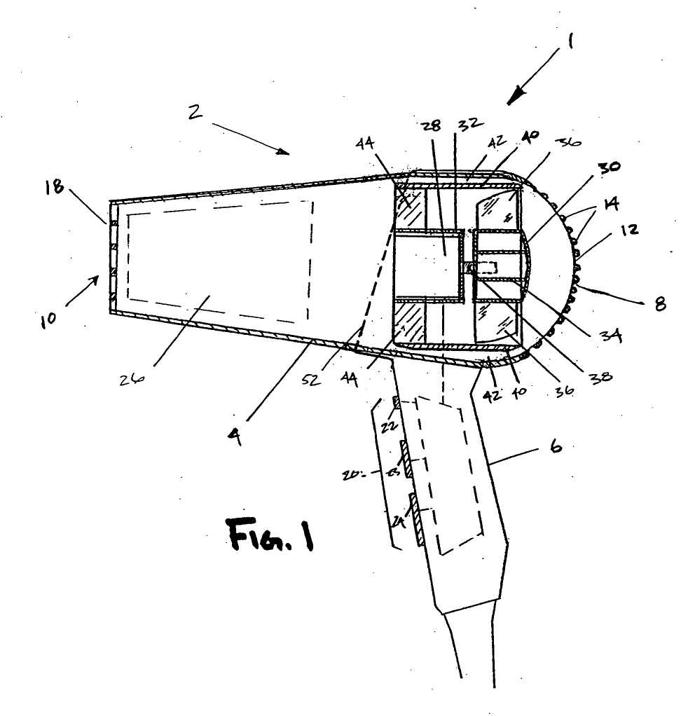

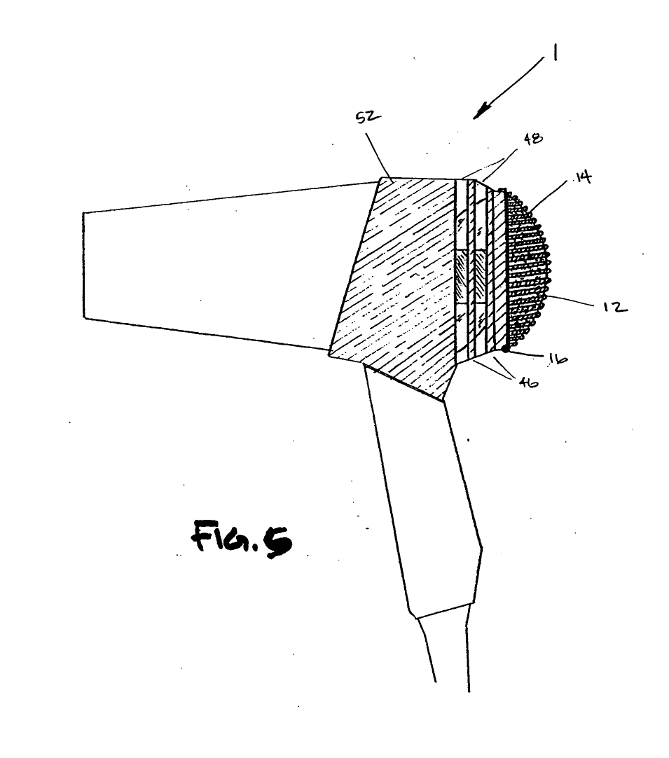

Referring to the drawings and, in particular, FIG. 1, there is shown an illustrative embodiment of an improved hair dryer generally represented by reference numeral 1. Dryer 1 has a housing 2, a heater 26 positioned in the housing, a motor 28 also positioned in the housing, a fan 30 operatively connected to motor 28, an inner sleeve 40 surrounding fan 30, and an outer sleeve 52 (shown clearly in FIG. 5) surrounding at least a portion of housing 2.

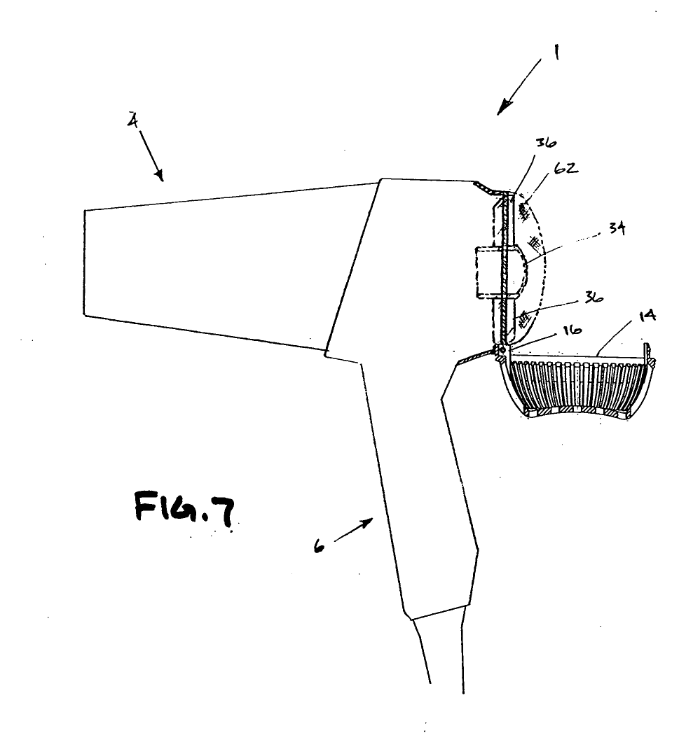

Housing 2 preferably has a barrel portion 4 and a handle portion 6. Preferably, barrel portion 4 is connected to handle portion 6 to facilitate easy handling and manipulation by a user. Also preferably, barrel portion 4 has an air inlet 8 and an air outlet 10. Air inlet 8 can have a filter element 12 and/or at least one first screen structure 14. Preferably, filter element 12 and/or at least one first screen structure 14 can be separate or separable from the housing, or rigidly fastened to the housing, or pivotally fastened to the housing by a hinge 16 as shown in FIG. 7. Air outlet 10 preferably has at least one second screen structure 18. Screen structures 14, 18 can be formed from and/or coated with a variety of different materials and/or combinations thereof suitable for reducing static electricity, reducing or eliminating the effects of corrosion, and/or dampening noise emitted from barrel portion 4 during the operation of the hair dryer. Preferably, the cross sectional airflow area of air inlet 8 is larger than that of air outlet 10. Also, air outlet 10 can cooperate with a variety of attachments (not shown) to provide a variety of different airflow effects.

Handle portion 6 can take any form suitable for gripping. Handle portion 6 can be formed from any of a variety of materials and/or combinations thereof providing an aesthetically pleasing appearance, a comfortable feel, an effective gripping surface, a thermally insulative effect, and/or a noise dampening effect. Also, such materials include, for example, Thermoplastic elastomers, solid and foamed rubbers, Gas injection molded hard plastic foams. Handle portion 6 also preferably supports a controller 20 operatively connected to heater 26, motor 28, fan 30, and various user operated control switches.

Preferably, at least one control switch is a cool shot switch 22 that, when employed, causes the instantaneous shutdown of at least a portion of heater 26, creating an airflow of lower temperature while maintaining and/or increasing/decreasing the airflow volume. When cool shot switch 22 is not employed, heater 26 operates in accordance with its intended purpose. The variety of switches may also include any switch control known for use with a hair dryer, such as, for example, a power on/off switch, a fan speed switch, and/or an ion discharge control switch.

Heater 26 is preferably positioned near air outlet 10. Heater 26 preferably has insulating boards (not shown) forming a cross and having a heater element (not shown) wound thereabout. Also, preferably heater 26 has a cylindrical heat-shield (not shown) surrounding the heater element and insulating boards. Heater 26 is not limited to the configuration just described. Heater 26 can have any configuration, and be formed of any material or combination of materials suitable to facilitate the intended operational purposes of hair dryer 1. For example, heater 26 can be made of resistance wire, doped or plated ceramics, resistance wire combined with ceramic radiators, and/or heat lamps.

Motor 28 preferably is positioned in barrel portion 4, but may also be positioned in a variety of positions in housing 2, such as, for example, in handle portion 6. The positioning of motor 28 is important since it effects the extent to which the motor can be acoustically isolated. Motor 28 is preferably fastened and/or supported in housing 2 using noise dampening structures, such as, for example, rubber or foam bushings, spring mounts of metal or molded plastic, wire or rubber cable suspensions and other shock absorbing connectors. Alternative fastening techniques may also be used. For example, motor 28 can be completely enveloped in a vibration-absorbing and/or noise dampening material, such as polyurethane foam, that is also capable of securing the motor in position. Noise dampening can be further enhanced by, as discussed in more detail hereafter, positioning motor 28 in a holder 32 that cooperates with fan 30. Motor 28 can be of any configuration and/or formed of a variety of materials suitable for accomplishing the operational purposes of hair dryer 1.

In addition, as the motor speed can have a significant impact on the overall sound level, motor 28 can be configured to efficiently and effectively operate at a slower motor speed and to cooperate with fan 30 such that fan 30 can be operated at a high rotational speed. The lower motor speed helps reduce both commutator brush noise and fan turbulence noise. Further, minimizing the motor speed results in increased motor life and reliability.

Fan 30 preferably is positioned between air inlet 8 and heater 26. As stated above, fan 30 is operatively connected to motor 28. Fan 30 preferably has a first hub 34 with a number of first propeller blades 36 projecting therefrom. Preferably, first hub 34 is connected at an end, to a first axial drive shaft 38 for transmitting a rotational motive force from motor 28 to the first hub. Preferably, first axial drive shaft 38 is connected to motor 28 through holder 32, which is positioned adjacent first hub 34. Preferably, holder 32 can also have any configuration and be formed of any material suitable for securely retaining and/or enclosing motor 28 so that vibration and/or undesirable noise is reduced or minimized during operation.

Further, to manage the high power input of heater 26, and still meet maximum allowed temperature rises required by national safety standards, a significant airflow, approximately 700 to 800 FPM, when measured through a standard anemometer tube, is preferred. It is preferred, therefore, to maximize the output of fan 30 and motor 28. Accordingly, fan 30 is preferably configured to move more air at slow rotational speeds.

In addition, at least one of the aforementioned switch controls is a quiet shot switch 24 that, when employed, causes an instantaneous reduction in the rotational speed of fan 30, facilitating a quieter operation. When quiet shot switch 24 is not employed, fan 30 operates in accordance with its intended purpose.

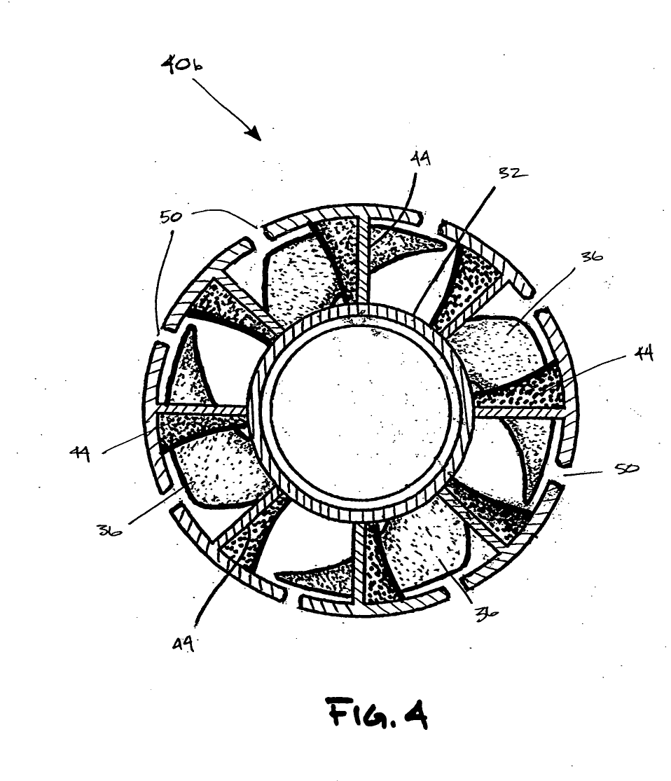

Inner sleeve 40 is preferably positioned in housing 2 so that a noise dampening air gap 42 is formed between the inner sleeve and the housing. Also preferably, inner sleeve 40 has a number of guides 44, shown more clearly in FIG. 4, for directing airflow generated by first fan 30. Guides 44 preferably integrally connect holder 32 and inner sleeve 40. However, guides 44 can also be formed as part of inner sleeve 40 only, or as part of holder 32 only, or even as an integral part of housing 2. Further, guides 44 can have a variety of configurations and/or arrangements appropriate to accomplish a variety of different airflow effects.

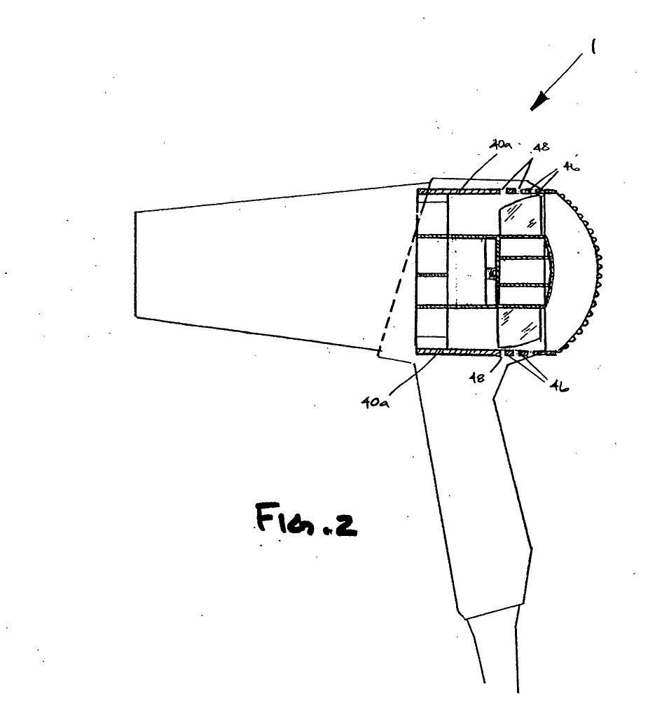

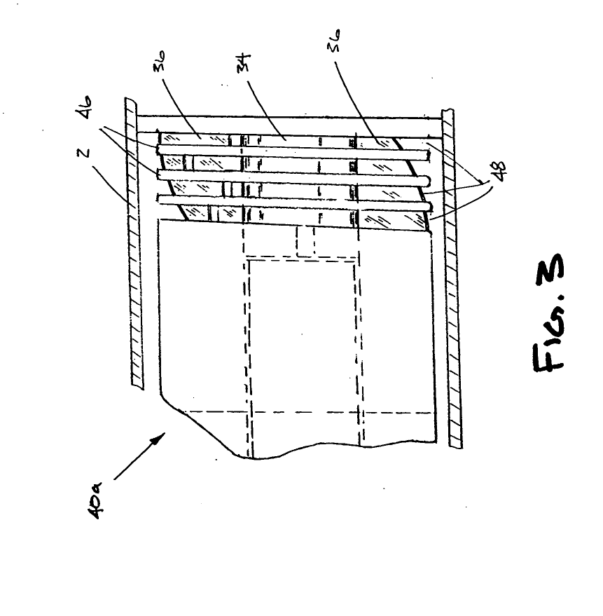

Referring to FIGS. 2 and 3, inner sleeve 40 takes the form of an annual ring defined sleeve 40a having one or more rings 46. Ring sleeve 40a preferably cooperates with first propeller blades 36 to convert blade tip vortices into useful airflow. Preferably, ring sleeve 40a also has one or more annular ring defined apertures 48 through which the ambient air between ring sleeve 40a and housing 2 combines with the blade tip vortices to provide a noise dampening effect. Housing 2 can also have one or more ring defined apertures, preferably proximate ring defined apertures 48 of inner sleeve 40a. Further, inner sleeve 40 can be integral with housing 2 such that air gap 42 is eliminated with rings 46 and ring defined apertures 48 being likewise integral with housing 2. This arrangement allows ambient air, outside of housing 2, to combine with the blade tip vortices, thereby augmenting the useful airflow and providing a noise dampening effect. Rings 46 and ring defined apertures 48 can have a variety shapes and/or configurations for cooperating with a variety of different hair dryer arrangements.

Referring to FIG. 4, inner sleeve 40 of this embodiment can preferably form an annular sleeve 40b having one or more longitudinally defined apertures 50 through which the ambient air between housing 2 and inner sleeve 40b combines with the blade tip vortices to provide a noise dampening effect. Housing 2 can also have one or more longitudinally defined apertures, preferably proximate the longitudinally defined apertures of inner sleeve 40b. Inner sleeve 40b can be integral with housing 2 so that air gap 42 is eliminated and longitudinally defined apertures 50 are in housing 2. This arrangement facilitates combining ambient air, outside of housing 2, with blade tip vortices, thereby augmenting the useful airflow and providing a noise dampening effect. Again, longitudinally defined apertures 50, like other features of hair dryer 1, can have a variety shapes and/or configurations for cooperating with a variety of different hair dryer arrangements.

Referring to FIG. 5, outer sleeve 52 of this embodiment preferably overlaps at least a portion of housing 2 and provides a further noise dampening effect. Outer sleeve 52 preferably provides a vibration and/or noise dampening layer to those portions of housing 2 supporting a noise generating component. Preferably, outer sleeve 52 is formed of a noise and/or vibration dampening material. Outer sleeve 52 can be integral with housing 2 or distinct therefrom. Outer sleeve 52 can have apertures corresponding to the above-identified housing apertures. Outer sleeve 52 preferably can also cooperate with filter element 12 and/or at least one first screen structure 14 of air inlet 8 to further reduce operational noise generated by hair dryer 1 during use.

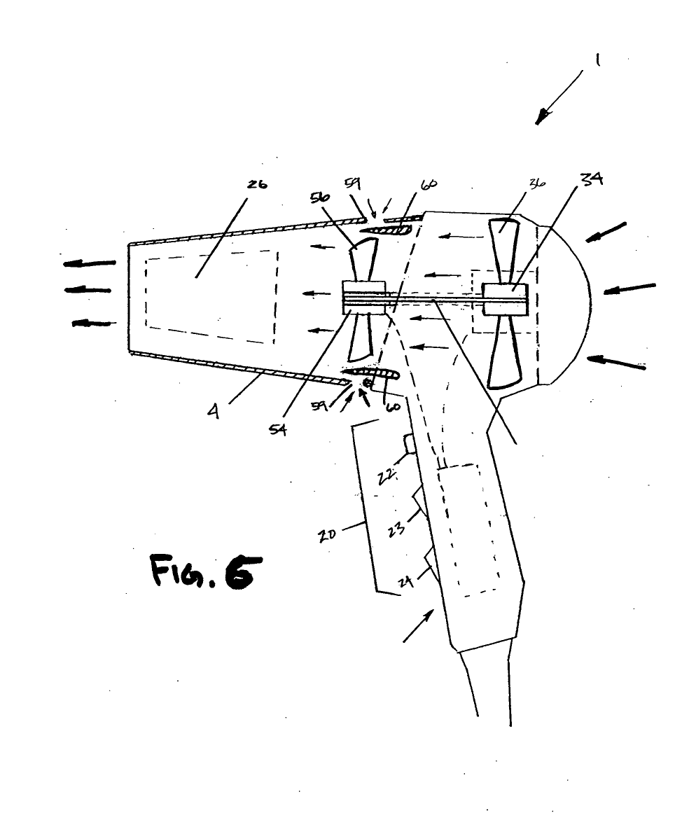

Referring to FIG. 6, fan 30 of this embodiment can have a second hub 54 with a number of second propeller blades 56 projecting therefrom, that is positioned at an axial distance from first hub 34. Preferably, first hub 34 and second hub 54 cooperate with a second axial drive shaft 58 operatively connected to motor 28. First hub 34 preferably is continuously connected to second axial drive shaft 58, and second hub 54 is preferably selectively or occasionally connected to second axial drive shaft 58. Preferably, this selective or occasional connection between second hub 54 and second axial drive shaft 58 can be accomplished by a fastener (not shown) of any type of device sufficient for such purposes. First hub 34, second hub 54, and motor 28 can each be separately operatively connected to two different drive shafts (not shown) such that first hub 34 and second hub 54 can each be selectively, separately operated. Preferably, controller 20 can cooperate with motor 28 and/or fan 30 to selectively and/or separately control the operation first hub 34 and second hub 54. Preferably, this selective, separate control enables a user to selectively dampen operational noise generated when the hair dryer is operated.

Additionally, housing 2 can have one or more apertures 59 therethrough, and one or more inner annular airfoils 60 disposed therein. Preferably, apertures 59 and airfoils 60 are positioned between air inlet 8 and air outlet 10 and at an axial downstream distance from inner sleeve 40. Preferably, apertures 59 and airfoils 60 cooperate with second hub 54 and second propeller blades 56 to augment airflow and reduce wind shear noise generated during operative use. The location and/or shape of apertures 59 and/or airfoils 60, as well as that of second hub 54 and second propeller blades 56 can be of any type suitable for augmenting airflow and/or dampening noise generated during operation of the hair dryer.

Referring to FIG. 7, fan 30 of this embodiment can be positioned so that first hub 34 and first propeller blades 36 are part-in and part-out of air inlet 8 of housing 2. This arrangement preferably facilitates combining ambient air, outside of housing 2, with blade tip vortices, to provide a noise dampening effect. Preferably, air inlet 8 cooperates with a protective screen 62 to protect fan 30 and provide safety to the user during the operational use of hair dryer 1. Protective screen 62 preferably has a configuration suitable for such protective purposes and can be formed from any material sufficient to facilitate such protective purposes, as well as to allow efficient airflow through air inlet 8 and into housing 2.

Each of the above-identified illustrative features can be combined in any of a variety of ways to accomplish the objectives of the present invention.

The present invention having been thus described with particular reference to the preferred forms thereof, it will be obvious that various changes and modifications may be made therein without departing from the spirit and scope of the present invention as defined herein.

What is claimed is:

1. A hair dryer comprising:
a housing having an air inlet and an air outlet;
a heater being positioned in said housing;
a motor being positioned in said housing; and
a fan being operatively connected to said motor, said fan having one or more hubs having a plurality of blades,
wherein said housing has an inner annular sleeve surrounding said fan, said inner annular sleeve being positioned to form an air gap between said housing and said inner annular sleeve.

2. The hair dryer of claim 1, wherein said inner annular sleeve has a plurality of guides for directing an airflow generated by said fan.

3. The hair dryer of claim 2, wherein said inner annular sleeve is connected to a holder by said guides.

4. The hair dryer of claim 3, wherein said holder retains and acoustically insulates said motor.

5. The hair dryer of claim 1, wherein said inner annular sleeve has one or more annular rings for converting into useful airflow, air vortices created by said plurality of blades.

6. The hair dryer of claim 5, wherein said inner annular sleeve has one or more annular ring defined apertures through which ambient air combines with said air vortices to have a noise dampening and/or an airflow augmenting effect.

7. The hair dryer of claim 6, wherein inner annular sleeve is integral with said housing and wherein said housing has one or more apertures that correspond to said one or more annular ring defined apertures so that air outside of said housing can combine with said air vortices.

8. The hair dryer of claim 1, wherein said inner annular sleeve has one or more longitudinally defined apertures through which ambient air combines with said air vortices to have a noise dampening and/or an airflow augmenting effect.

9. The hair dryer of claim 8, wherein said inner annular sleeve is integral with said housing and wherein said housing has one or more apertures that correspond to said one or more annular longitudinally defined apertures so that air outside of said housing can combine with said air vortices.

10. The hair dryer of claim 1, further comprising a noise and/or vibration dampening outer sleeve overlapping at least a portion of said housing.

11. The hair dryer of claim 1, wherein said fan has a first hub with a plurality of first propeller blades and a second hub with a plurality of second propeller blades.

12. The hair dryer of claim 11, wherein said first hub and said second hub operatively cooperate with said motor via an axial drive shaft.

13. The hair dryer of claim 12, wherein said first hub is continuously operatively connected to said axial drive shaft and said second hub is selectively connected to said axial drive shaft.

14. The hair dryer of claim 13, further comprising a controller for cooperating with said motor and/or said fan to selectively and/or separately control the operation of said first hub and/or said second hub.

15. The hair dryer of claim 11, wherein said housing has one or more apertures positioned between said air inlet and said air outlet and at an axial downstream distance from said inner annular sleeve.

16. The hair dryer of claim 15, further comprising one or more inner annular airfoils positioned proximate said one or more apertures to separate said apertures from said second hub.

17. The hair dryer of claim 1, wherein said fan is positioned part-in and part-out of said air inlet of said housing.

18. A hair dryer comprising:
a housing having an air inlet and an air outlet;
a heater being positioned in said housing;
a motor being positioned in said housing; and
a fan positioned in said housing and being operatively connected to said motor for generating an airflow;
an inner annular sleeve surrounding said fan,
Wherein said inner annular sleeve is positioned to form an air gap between said housing and said inner annular sleeve, and wherein said inner annular sleeve has one or more apertures.

19. The hair dryer of claim 18, wherein said inner annular sleeve has a plurality of guides for directing an airflow generated by said fan.

20. The hair dryer of claim 19, wherein said one or more sleeve apertures cooperate with said fan to minimize air vortices created by said fan during operation.

21. The hair dryer of claim 20, wherein said inner annular sleeve is integral with said housing and wherein said housing has one or more apertures corresponding to said one or more sleeve apertures so that air outside of said housing can combine with said air vortices.

22. The hair dryer of claim 18, further comprising a noise and/or vibration dampening outer sleeve overlapping at least a portion of said housing.

23. The hair dryer of claim 18, wherein said fan has a first hub with a plurality of first propeller blades and a second hub with a plurality of second propeller blades.

24. The hair dryer of claim 23, wherein said first hub and said second hub operatively cooperate with said motor via an axial drive shaft.

25. The hair dryer of claim 24, wherein said first hub is continuously operatively connected to said axial drive shaft and said second hub is selectively connected to said axial drive shaft.

26. The hair dryer of claim 25, further comprising a controller for cooperating with said motor and/or said fan to selectively and/or separately control the operation of said first hub and/or said second hub.

27. The hair dryer of claim 18, wherein said housing has one or more apertures positioned between said air inlet and said air outlet and at an axial downstream distance from said inner annular sleeve.

28. The hair dryer of claim 27, further comprising one or more inner annular airfoils positioned proximate said one or more housing apertures to separate said one or more housing apertures from said second hub.

29. The hair dryer of claim 18, wherein said fan is positioned part-in and part-out of said air inlet of said housing.

30. A hair dryer comprising:
a housing having an air inlet and an air outlet;
a heater being positioned in said housing;
a motor being positioned in said housing;
a fan having one or more hubs with a plurality of propeller blades, said fan being operatively connected to said motor; and
a controller for selectively controlling said one or more hubs and/or said motor to selectively and/or separately manipulate the operation thereof,
wherein said one or more housing apertures are positioned between said air inlet and said air outlet.

31. The hair dryer of claim 30, wherein said housing has one or more inner airfoils.

32. The hair dryer of claim 31, wherein said housing has an inner annular sleeve surrounding said fan and positioned to form with said housing an air gap therebetween.

33. A hair dryer comprising:
a housing having an air inlet and an air outlet;
a heater being positioned in said housing;
a motor being positioned in said housing; and
a fan being operatively connected to said motor and being positioned part-in and part-out of said housing.

34. A hair dryer comprising:
a housing having an air inlet and an air outlet;
a heater being positioned in said housing;
a fan for moving a high volume of air at slow rotational speeds;
a motor operatively connected to said fan to selectively drive said fan at high and/or low rotational speeds while operating at reduced motor speeds; and
a quiet shot control switch for instantaneously reducing said rotational speeds of said fan to facilitate a quieter operation thereof.
